(19) United States
(12) Patent Application Publication
(10) Pub. No.: US 2016/0215927 A1
(43) Pub. Date: Jul. 28, 2016

(54) DUAL PUMP OIL LEVEL SYSTEM AND METHOD

(71) Applicants: Richard Nelson, Rosamond, CA (US); Robert M Nelson, Rosamond, CA (US); Joe D Hedges, Rosamond, CA (US)

(72) Inventors: Richard Nelson, Rosamond, CA (US); Robert M Nelson, Rosamond, CA (US); Joe D Hedges, Rosamond, CA (US)

(21) Appl. No.: 15/087,886

(22) Filed: Mar. 31, 2016

Related U.S. Application Data
(62) Division of application No. 13/998,630, filed on Nov. 18, 2013.

(51) Int. Cl. F16N 29/02; F04B 23/02; F16N 39/04; F16N 37/00

(52) U.S. Cl. CPC F16N 29/02; F16N 37/00; F04B 23/02; F16N 39/04

(57) ABSTRACT

Two pump oil level system and method for exchange of a fluid between an apparatus reservoir and a reserve reservoir. A first pump is connected to an apparatus reservoir to withdraw fluid to maintain a fluid level and to deliver fluid to a reserve reservoir. A second pump returns oil to the apparatus reservoir from the reserve reservoir. The first pump transfers fluid at a volume relatively larger than the second pump. The first and second pump flow conduits may have sensors installed to identify the fluid being pumped, such as air or oil, and a data processing device in communication with the sensors may evaluate fluid to determine system operation, and to estimate pump operating conditions and fluid viscosity in order to enhance pump flow by operation of heaters, and to verify correct maintenance of oil levels and that the reserve reservoir has oil. Data is suitable for transmitting.

### RELATED APPLICATION

The present application is a Divisional of, and claims the benefit of priority to, the United States Patent Application for “DUAL PUMP OIL LEVEL SYSTEM AND METHOD” Ser. No. 13/998,630, filed on Nov. 18, 2013, currently co-pending.

### BACKGROUND OF THE INVENTION

This invention relates to systems and methods for control of a two pump system for fluid exchange between an apparatus reservoir and a reserve reservoir and subsequent maintenance of the apparatus reservoir oil level. The new system connects a first pump for fluid flow between the apparatus reservoir and an inlet port of the reserve reservoir and a second pump for fluid flow between the reserve reservoir and the apparatus reservoir. A pump controller determines operation between the first and second pumps. Delivery of the first pump fluid to the inlet port of the reserve reservoir may be to a location above or adjacent to the reserve reservoir output port to allow warmed fluid to accumulate in the reserve reservoir in a localized zone suitable for retrieval by the second pump. Auxiliary line heating apparatus and monitoring apparatus that may include data processing elements to identify the tolerances of the system operation and reservoir oil levels and high oil viscosity may be included.

Overflow fluid exchange oil level systems are well established in the market for stationary applications, utilizing a pump to fill an apparatus reservoir from a secondary or reserve reservoir and an overflow conduit for overflowing and returning excess oil back to the reserve reservoir from the apparatus reservoir; thus to maintain the apparatus oil level at the point of overflow of oil from the apparatus reservoir and to cause a recirculation or mixing of oils between the apparatus reservoir and the reserve reservoir. With overflow systems the rate of flow from the overflow to the reserve reservoir must be higher than the rate of flow delivered by the pump to the apparatus reservoir or the system will overfill the apparatus reservoir.

U.S. Pat. No. 4,376,449, issued Mar. 15, 1983, which is hereby incorporated by reference, discloses a fluid exchange oil level system that utilizes a first and a second electromagnetic piston pump to exchange fluid between an apparatus reservoir and a reserve reservoir and simultaneously control the oil level in the apparatus reservoir. The first pump is also a sensing pump, which runs continuously pumping either air or oil from a withdrawal point at the level to be maintained in the apparatus reservoir and delivering this oil to the reserve reservoir. The pump senses its pumped flow to identify whether it is pumping air or oil and uses the sensing of air to trigger operation of the second pump to return oil from the reserve reservoir to the apparatus reservoir. The use of this trigger also helps to guarantee against overfilling the apparatus reservoir which might happen if the second pump ran independently without the requirement of a trigger. Repeated triggering from the first pump and subsequent operation of the second pump continues until the second pump has raised the level in the apparatus reservoir enough that oil is again being pumped by the first pump and the second pump ceases operation awaiting air sensing in the first pump.

The air sensing signal output generated by a pump as in U.S. Pat. No. 4,376,449, in addition to being used to directly control the apparatus reservoir oil level as described above also has separate utility for information purposes. While this type of pump as used generates sufficient data to verify correct operation and maintenance of the apparatus reservoir oil level the signal output is in the form of an on or off binary pulse readable on an Light Emitting Diode (LED) visible as a blinking light and may be difficult for many people to interpret. A mixed signal of air and liquid pulses which in appearance is an irregular blinking of the LED indicates that the apparatus reservoir level is correct, but there is no further processing of the signal to give a simplified output to indicate in or out of tolerance operation of the system nor are the signals particularly formatted or data processed suitable for data storage, data retrieval, wireless transmission, or for control purposes.

Using a pump such as that in U.S. Pat. No. 4,376,449 to provide an air trigger to activate a second pump works best in applications where the oil flows easily such as when warm and of low oil viscosity. At extreme cold ambient temperatures, as oil becomes highly viscous and begins to approach a solid state or semi-solid state it resists pumping or flow. Semi solid oil may block flow from the apparatus reservoir into the first pump, from the reserve reservoir into the second pump and through lines or fluid conduits into and out of each pump as well as between reservoirs. Further the lack of fluid flow can block the ability of the first pump to trigger the second pump, because the sensing signal of air by a pump in this type of system is a function of its pump piston velocity which increases when pumping air and diminishes when pumping oil and further diminishes when fluid circuits are restricted enough to inhibit flow. In an identical manner sensing of fluid flow for information alone can become inhibited by frozen semi-solid or highly viscous oils, making the derivation of information less reliable.

With systems such as that of U.S. Pat. No. 4,376,449, in worst case cold ambient operating conditions oil in the reserve reservoir and lines may be chilled to a semi-solid highly viscous state. In such a case fluid flow from the first pump will pressurize the reserve reservoir, dead head the first pump and eventually block the sensing of air by the first pump by slowing, retarding and blocking motion of the pumping piston and thus inhibit the trigger of the second pump operation. All flow back to the apparatus reservoir will stop and the system will fail to control the level in the apparatus reservoir. Because the reserve reservoir can become pressurized it is common to deliver fluids from the first pump to an upper portion of the reserve reservoir and vent the reserve reservoir to atmosphere; thus to eliminate the pressurizing conditions which might inhibit sensing by the first pump. However, venting the reserve reservoir leaves it unacceptably vulnerable to overflowing. With such conditions reservoirs are often heated to facilitate flow. Established practice with fluid exchange oil systems is often wasteful of heat, with users attempting to heat the entire volume of the reserve reservoir and at the same time wrapping of heaters and insulation over fluid conduits or hoses. The total heat needed to warm a reservoir and fluid conduits or lines can be an excessive demand on power available to the equipment serviced.

There exists a need for a two pump system having flow circuits comparable to those of U.S. Pat. No. 4,376,449, that are not dependent on a trigger based on air or oil to actuate operation of a second pump, that provides a safe operation by a controller between the first and second pump, and that maintains system flow without needing a reserve reservoir atmospheric vent. The system may use the sensing of air and oil flow and process the data of the sensing to verify that system operation is in or out of tolerance to identify the oil level of the apparatus reservoir, and to identify the availability of oil in the reserve reservoir. The system may identify that system fluid flow is acceptable thus to determine when oil viscosity is excessive requiring that external heat should be applied.

### SUMMARY OF THE INVENTION

The present invention is directed to two pump oil level control systems and methods for exchange of a fluid between an apparatus reservoir and a reserve reservoir and subsequent maintenance of the apparatus reservoir level. A first pump is connected for fluid communication at an inlet port to an apparatus conduit positioned to withdraw fluid at an open tip end at a level to maintain fluid in the apparatus reservoir. An outlet port of the first pump is connected by a first conduit to an inlet port in a reserve reservoir. A second pump is connected at its inlet port to the outlet port of the reserve reservoir by a second conduit. An outlet port of the second pump is connected by a third conduit to an anti-siphon device and the anti-siphon device is connected by a fourth conduit to an inlet port within the apparatus reservoir. The inlet port in the reserve reservoir may be above and adjacent to the outlet port of the reserve reservoir whereby warmed oils removed from the apparatus reservoir by the first pump may be stored within colder oils in the reserve reservoir and be available for removal by the second pump from the outlet port. The first pump transfers fluid at a flow rate relatively larger than the flow rate of that transferred by the second pump, the relatively larger flow rate being sufficient that oil in the apparatus reservoir will be maintained at the level defined by open tip end in the apparatus reservoir because oil above this end is transferred back to the reserve reservoir by the first pump. The quantity of the flow of the first pump must be greater than one times the flow of the second pump (>1.0) and to maintain this difference in flow between the first pump and the second pump the two pumps are connected by a pump controller that controls the sequence of operation between the first and second pump to provide a proper rate or frequency of pump operations each according to the comparative pumping flow capability of the first and second pump respectively to thus create the proper rates of flow in the conduits between the reserve reservoir and the apparatus reservoir.

The first and second pumps may have sensors installed to identify the fluid being pumped and whether it is air or oil, and a remote data processing device in communication with the sensors may evaluate data to estimate pump operating conditions to identify in and out of tolerance operating conditions including maintenance of the apparatus reservoir oil level or the presence of oil in the reserve reservoir and also oil viscosity in order to control flows generated by the first and second pumps by applied power and operation of an auxiliary applied thermal line heaters and also to provide for remote data retrieval and transmission.

These and other features, aspects and advantages of the present invention will become better understood with reference to the following drawings, descriptions and claims.

### BRIEF DESCRIPTION OF THE DRAWINGS

FIG. 1 illustrates a schematic of a two pump fluid exchange and oil level control system according to an embodiment of the invention;

FIG. 2 illustrates a device and method whereby operation of a two pump oil level system may be assessed by a sensor and data processor combination according to an embodiment of the invention.

FIG. 3 illustrates a method of data process and analysis of the fluid sensing of flow in the first pump conduit according to an embodiment of the invention.

### DETAILED DESCRIPTION

The following detailed description represents the best currently contemplated modes for carrying out the invention. The description is not to be taken in a limiting sense, but is made merely for the purpose of illustrating the general principles of the invention.

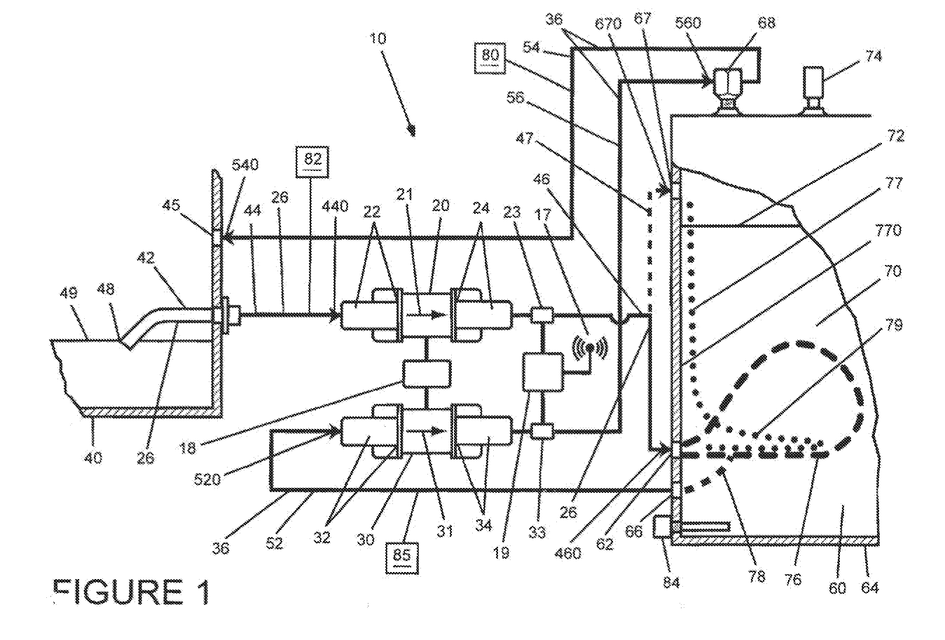

Referring to FIG. 1, the system 10 uses the operation of a first pump 20 and a second pump 30 to control the oil level in an apparatus reservoir 40 from a reserve reservoir 60 and exchange fluids between the apparatus reservoir 40 and the reserve reservoir 60. Both the first pump 20 and the second pump 30 can have various structures, but testing has determined that the most appropriate kind of pump is an electromagnetically driven piston pump. Design variations and operation of this type of pump are well known in the art; and they can be self-priming and can pump air without internal damage. The first pump 20 is built with a central tubular structure 21, illustrated with an arrow showing the direction of flow through the pump 20 and is confined on its opposite ends by the first pump inlet assembly 22 and the first pump outlet assembly 24. The second pump 30 is built with a central tubular structure 31, illustrated with an arrow showing the direction of flow through the pump 30 and is confined on its opposite ends by the second pump inlet assembly 32 and the second pump outlet assembly 34.

The first pump 20 by its operation causes suction at the first pump inlet assembly 22, which in turn causes flow from the apparatus reservoir 40, through the apparatus reservoir suction tube 42, from its point of withdrawal at the open tube end 48, and through apparatus conduit 44 to the first pump inlet assembly 22. The arrow 440 illustrates the direction of flow through apparatus 30 conduit 44. Flow out of the pump 20 is through the first pump outlet assembly 24, first conduit 46, and first sensor 23 which is an optional element, and into the port 62 of the reserve reservoir 60 through a generally vertical portion of reservoir wall 64. The arrow 460 illustrates the direction of flow through the first conduit 46. Operation of the second pump 30 causes suction at its second pump inlet assembly 32 and in turn causes suction at the outlet port 66 of the reserve reservoir 60, and flow through the second conduit 52, and into the second pump inlet assembly 32 of the second pump 30. The arrow 520 illustrates the direction of flow through the second conduit 52. Delivery from the second pump 30 is from the pump outlet assembly 34, through the third conduit 56, and through second sensor 33 which is an optional element, to the anti-siphon valve 68. The arrow 560 illustrates the direction of flow through the third conduit 56. Flow continues through the anti-siphon valve 68 and the fourth conduit 54 into the port 45 of the apparatus reservoir 40. The arrow 540 illustrates the direction of flow through the fourth conduit 54.

The anti-siphon valve 68 contains internal valve parts not shown which can have various valve construction in ways known to the arts that allow air transferred into the reserve reservoir 60 from the apparatus reservoir 40 by the operation of the first pump 20 to vent directly into the fourth conduit 54 for return to the apparatus reservoir 40 along with oil flow created by the second pump 30. The anti-siphon valve 68 can also interrupt a siphoning of oil from the reserve reservoir 60 to the apparatus reservoir 40 if it occurs and use of an ant-siphon valve 68 is an item currently well known to the arts. The anti-siphon valve 68 allows the system 10 to operate without optional vent 74 because any air transferred to the reserve reservoir 60 by the first pump 20 can return to the apparatus reservoir 40 by venting through the fourth conduit 54.

The flow circuits from the apparatus reservoir 40 are the suction tube 42, apparatus conduit 44, pump 20 and first conduit 46, optional first sensor 23 to the reserve reservoir 60 and are referenced as the first pump conduit 26 indicated with several reference points 26 in FIG. 1. The optional first sensor 23 can be in any portion of the first pump conduit 26. Similarly, the flow circuits from the reserve reservoir 60 that are the second conduit 52, pump 30, third conduit 56, optional second sensor 33, anti-siphon valve 68, fourth conduit 54 and port 45 to the apparatus reservoir 40 are referenced as the second pump conduit 36 indicated with several reference points 36 in FIG. 1. The optional second sensor 33 can be in any portion of the second pump conduit 36.

In operation the first pump conduit 26 and the second pump conduit 36 each flow by a sequenced pattern of repetitive pumping operations between pump 20 and pump 30 respectively and are controlled by the pump controller 18. Operation depends on the pump 20 generating a flow through its first pump conduit 26 at a rate of flow which is relatively greater than that generated by pump 30 through its second pump conduit 36. As a quantity, the rate of flow through the first pump conduit 26 must be greater than 1 times (>1.0) the volume of flow through the second pump conduit 36. By this definition the rate of flow from the apparatus reservoir 40 into the open tube end 48 of the suction tube 42 and delivered through the first pump conduit 26 to the reserve reservoir 60 must be sufficient such that the oil being pumped into the apparatus reservoir 40 through the second pump conduit 36 does not fill the apparatus reservoir 40 fast enough to sustainably rise above the tube end 48 without this oil being removed back to the reserve reservoir 60 by the first pump 20. There may be temporary fluctuations such as those caused by manual servicing into the apparatus reservoir 40 or power fluctuations such as those encountered in an engine which may cause fluctuations or perturbations in the apparatus reservoir 40 oil level, all which are self-correctable by the system 10. If oil is below the open tube end in the apparatus reservoir 40 flow from the second pump conduit 36 will raise the oil level 49 to the height of the suction tube end 48 and will be maintained there.

To cause the different flow rates between the first pump conduit 26 and the second pump conduit 36 we may choose as an example that the first pump 20 and second pump 30 be identical pumps controlled by the pump controller 18 to operate sequentially with a different frequency, pattern or number of operations comparatively; or as another example that the second pump 30 may be of smaller construction or size and having lesser flow capability than the first pump 20 in which case the pump controller 18 may cause a sequence of operation with the first pump 20 operating then the second pump 30 operating each in turn. These two examples of sequence of operation between the first pump 20 and the second pump 30 are only two of many possibilities of sequencing by the pump controller 18 as may be needed with varying construction of the first pump 20 and the second pump 30 and the relative flow capacities of each. The pump controller 18 may be a programmed control device or may be one of other various electrical or mechanical devices known to the arts capable to control the sequence of and proper number of pump operations between the first pump 20 and the second pump 30. The first pump conduit 26 and the second pump conduit 36 as described need no additional operating elements, devices or control functions to maintain the oil level 49.

In operation the second pump 30 will always attempt to deliver oil regardless of whether the oil is substantially fluid or semi-solid in the second pump conduit 36 and reserve reservoir 60. This minimizes any advantage to deliver the oil flowing through the first pump circuit 26 to the top of the reserve reservoir 60 through alternate flow circuit 47, which is illustrated with dotted lines, and delivers into port 67; and further minimizes the need to vent the reserve reservoir 60 as by optional vent 74, although in system 10 the alternate flow circuit 47 and the optional vent 74 will not interfere with operation of our first pump 20 or our second pump 30 if used. The direction of flow through the optional flow circuit 47 is illustrated by the arrow 670.

Extensive testing in cold weather ambient conditions found unexpectedly the most appropriate place to transfer the fluid pumped within the flow circuit 26 is to a location such as port 62 adjacent to or above the point of withdrawal from the secondary reservoir 60 at port 66. Fluid pumped into the reserve reservoir 60 at port 62, when the oil 70 in the secondary reservoir 60 is semi-solid due to cold temperatures, blows a bubble resembling the bubble shape 76 on the oil 70 illustrated in FIG. 1 with dotted lines. The poor thermal conductivity of semi-solid oil keeps warmer oils pumped into this bubble shape 76 area from the apparatus reservoir 40 from intermixing easily with the colder oil 70. Eventually the bubble shape 76, whether composed of oil warmer than the oils 70 or whether composed of air will develop enough pressure within the containment of the oil 70 to rupture or form a ruptured path 77 to the top of the oil level 72 in the reserve reservoir 60. This ruptured path 77 is illustrated along the vertical side wall 770 by the dotted line also ruptured path 77. As the bubble shape 76 ruptures it then deflates to deflated area 79 as warm oil moves upward on ruptured path 77. Both the ruptured path 77 and the deflated area 79 of the former bubble shape 76 are able to store the oils from the flow circuit 26 which are warmer than that oil 70 stored in the reserve reservoir 60, and this warmer stored oil is available to the second pump fluid circuit 36 for removal through the area within suction plume 78 also shown in dotted lines. Using the method of delivering the oil pumped by the first pump 20 to an area adjacent for pumping from the reservoir 60 by the second pump 30, reduces the losses of heat in fluid transferred from the apparatus reservoir 40 to the secondary reservoir 60 and allows this oil to be quickly used by the second pump 30. The colder and semi-solid oils 70 have become a thermal insulation for containment for warmer oils.

This structure and method also works to advantage in the system when applying heat from secondary sources, such as from second conduit heater 85 or apparatus conduit heater 82 or fourth conduit heater 80 which are optional heat lines selectively inserted into conduits and may have utility at any of the portions of the first pump conduit 26 or the second pump conduit 36. Reserve reservoir heater 84 which is also optional can be of any of the commercially available types including immersion heaters and or heat exchangers such as those operated by engine coolant. Adding heat sources to any portion of the system 10 may shorten the time required to reach full fluid exchange flow. The establishment and use of a thermal containment of the ruptured path 77 to store warm oils can assist in containing the heat output of the apparatus conduit heater 82 or the reserve reservoir heater 84 thus to reduce heat losses where oil is thus heated and to allow a smaller amount of heat to be applied. It can be extremely useful especially in operations such as heavy equipment where extra power is of premium value and a goal is to allow the heaters including the apparatus conduit heater 82, or the reserve reservoir heater 84 or the second conduit heater 85 or the fourth conduit heater 80 to be turned off when flow in the system 10 is established. While many kinds of external and internal hose heaters exist, we have found useful a common mineral insulated heat element that can be directly inserted into conduits and is of a kind well known to the arts. This kind of heater can take high temperatures, can meet stringent explosion proof standards and uses very low quantities of power.

We may optionally apply air or oil sensors such as first sensor 23 or second sensor 33 to sense the flow by the first pump 20 and by second pump 30 to identify when air or oil is being pumped in either the first pump conduit 26 or the second pump conduit 36 respectively. We have shown only one of the potential locations for the first sensor 23 and the second sensor 33 as an example but in reality these sensors may be appropriately used in alternate locations in their respective first pump conduit 26 and second pump conduit 36 without loss of function and we consider such variations equivalent. Air or oil sensors can be one of a large number of commercially available sensors that can identify both air and oil both or can identify either air or oil separately. Such sensors are largely known in the arts and include but are not limited to pump velocity sensors, dielectric constant sensors, viscosity sensors and flow sensors and pressure or vacuum transducers or switches. We consider any of the many different sensor kinds equivalent. Information derived by knowing the kind of fluid flowing through a circuit such as first pump circuit 26 or second pump circuit 36, whether air or oil or a mix, can allow the user to monitor operation of system 10 and can help verify whether or not the oil level 49 is being maintained in the apparatus reservoir 40 or whether or not the reserve reservoir 60 has oil or is empty or whether oil viscosity in the system 10 is slowing flow. It is useful to utilize the data derived from sensing the flow of first pump conduit 26 or second pump conduit 36 in interpretive circuitry in a data processor 19 which may also use data communication systems such as transmitter 17. This which will become more important in the future as more industrial process equipment is also remotely controlled or monitored automatically without the need for human interaction.

It has been found by lab testing that the data processor 19 can utilize the data generated by the sensing of the flow of pumps 20 and 30 either air or oil or a mix of both to control the operation of heaters. Out of tolerance and unacceptable operation by the system 10 can generate air or oil signals in large disproportion to each other when the first pump 20 or second pump 30 is pumping semi-solid very cold high viscosity oils as an indication that flows are not adequate to provide full system 10 function, in which case the output might indicate sensing by the first sensor 23 for long periods of either air or oil without fluctuating back to the opposite state. As an example, a continuous or nearly continuous sensing of air by sensor 23 might be an indicator of difficulty of the second pump 30 to deliver oil to the apparatus reservoir thus causing primarily air to flow through the first pump conduit 26 thus to be sensed by the first sensor 23 as air. Conversely, continued sensing of oil at the first sensor 23 might indicate flow through the first pump conduit 26 of primarily oil indicating a disability of the first pump 20 to pump down the level 49 to the end 48 in the apparatus reservoir 40 and thus a failure to maintain the oil level 49. Failure to adequately pump by either pump 20 or pump 30 might be indicative of poor fluid exchange by the system 10 usually because of very high oil viscosity, and can lead to inability of the system to maintain the oil level 49 of the apparatus reservoir 40. In this case the data processor 19 can indicate the oil viscosity of the system 10 thus to identify the heating needs required to maintain flow through our first pump 20 and second pump 30 and in response to also control the operation of apparatus heater 82, second conduit heater 85 and fourth conduit heater 80 or reserve reservoir heater 84 or others to try and develop flow through the circuits 26 and 36 and thus to fix or correct out of tolerance operating conditions.

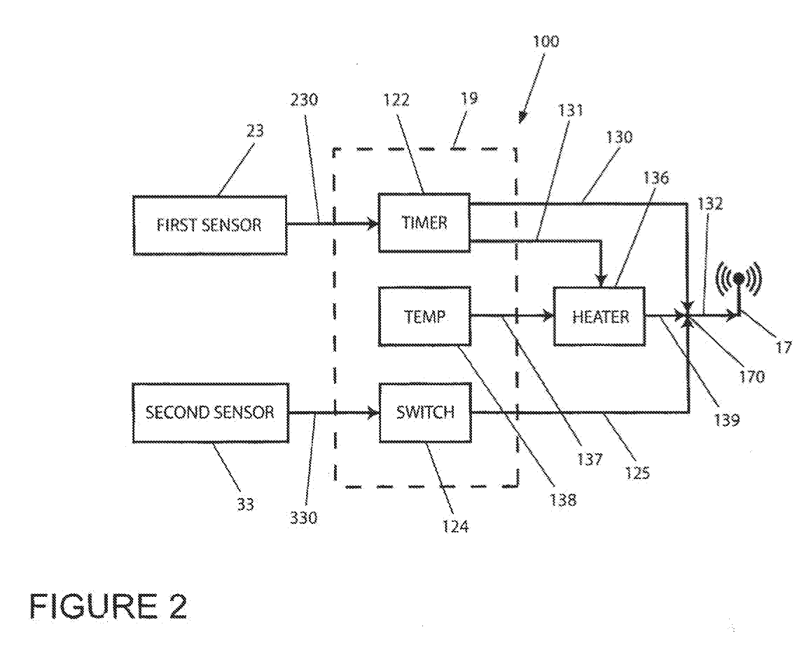

Referring to FIG. 2, a method and device is illustrated whereby operation of a two pump fluid exchange and oil level control system may be assessed by a first sensor 23, a second sensor 33 and data processor 19 combination. With the sensor processor system 100 the data processor 19 utilizes the sensing of air and oil of the first sensor 23 as conveyed through the first data path 230 and the second sensor 33 as conveyed through the second data path 330 to monitor the system 10 for operating condition tolerances to indicate maintenance of the apparatus reservoir 40 oil level 49 and the reserve reservoir 60 for the presence of oil and system flow for control of operation of heaters, and for transmitting or utilizing or displaying data for information purposes.

For the data processor 19 to process the data of the first sensor 23 it must analyze data sampling of air and oil sensing: over a predetermined time interval sufficient for the system 10 to have developed acceptable operation wherein a verification of the oil level 49 in the apparatus reservoir 40 should have occurred, or over a similarly prescribed period of time that the operation of system 10 is proven unacceptable because the level 49 is not verified The timer 122 of the data processor 19 is utilized to determine within the predetermined length of time whether either air or oil signals alone from sensor 23 continue without alternating from one to the other. When the signals have not alternated from one to another we define this condition as having had no event, and when the signals alternate from one to another we define this condition as having an event. Air signals alone from first sensor 23 for a prescribed timed period, or oil signals alone from a similarly chosen timed period, both as conveyed through the first data path 230, would indicate that no event has occurred during this predetermined length of time thus proving unacceptable operation of the system 10. In the arts the timer 122 having thus exceeded its timed period without an event is often described as having timed out. Alternately the timer is said by persons skilled in the arts to reset, meaning that in the predetermined length of time an event has occurred proving acceptable operation of the system 10, because both air and oil signals have been received from the first sensor 23 and that the timer 122 has reset thus starting a new predetermined time limit for evaluation of data sampled. Information indicating either acceptable or unacceptable operation of the system 10 may be transmitted or outputted via timer data path 130 to a data collection point 170 where it can be displayed by various methods not shown and conveyed by the transmitter data path 132 to the transmitter 17.

Similar logic is commonly referred to as watchdog logic software but can be replaced by a large variety of timer hardware including but not limited to the common 555 integrated circuit timer (not shown). Timers are highly reliable and can interpret irregular data such as generated by the first sensor 23. We have chosen to use processing logic utilizing EPROM components (not shown) which can have programming burned in as it is referred to in the arts and can be re-programmed when necessary, including to change time intervals. These same data processing components in data processor 19 can also monitor the data of second sensor 33 through second data path 330, and output data from the switch 124 as it switches its output between the second sensor 33 sensing air or oil, through the switch data path 125 to the data collection point 170 and through the transmitter data path 132 to the transmitter 17. The switching on receipt of air or oil signals from the second sensor 33 needs no predetermined time interval for evaluation from timer 122 because we are evaluating only the presence or absence of oil.

The transmitter can use various standard communication protocol including CAN, RS 232 or others. The use the data processor 19. This is a highly useful function of this two pump system and one that completes the hardware and logic lacking in older systems. In the industrial process market the cost for maintenance of such equipment as large engines transmissions and gear cases among other things can be a large portion of the cost of a plant operation and the trend worldwide is to create industrial sites with as few human personnel as possible especially when the ambient temperatures or physical dangers of the operating conditions are highly adverse or dangerous to human life. The ability, to create oil level control systems that are self-monitoring is of enormous value.

Out of tolerance and unacceptable system 10 operation data having no event, and interpreted by the timer 122 as a time out can be used for assessing oil viscosity in the system 10 because during periods of cold operation the lack of fluctuation from sensing air and oil both by the sensor 23 indicates slowed flow in system 10 which is a function of oil viscosity. This information can be used to activate and deactivate the heater elements 136 through the heater data path 131. The heater elements 136 include those of apparatus conduit heater 82, second conduit heater 85, fourth conduit heater 80 or reserve reservoir heater 84 as data from the first sensor 23 is deemed to be in or out of tolerance as determined by the timer 122. This provides a highly reliable and inexpensive alternative to complex expensive and unreliable thermostats commonly used to control heaters. It can be chosen to use sensing by temperature sensor 138, which through the temperature data path 137 connects to the heater elements 136, to turn on the heater elements 136 during times such as during extreme cold ambient temperatures and when there is insufficient time to determine system operating conditions such as at system start up when it is known that heat will be beneficial. The temperature sensor 138 may measure temperature at various locations including in the first conduit 26 for instance or even may measure ambient temperatures for system 10 as it is only needed for start-up conditions. Many of various known devices can provide the function of measuring temperature including common thermistors or thermostats. Data on heater operation can be conveyed by heater data path 139 to the collection point 170.

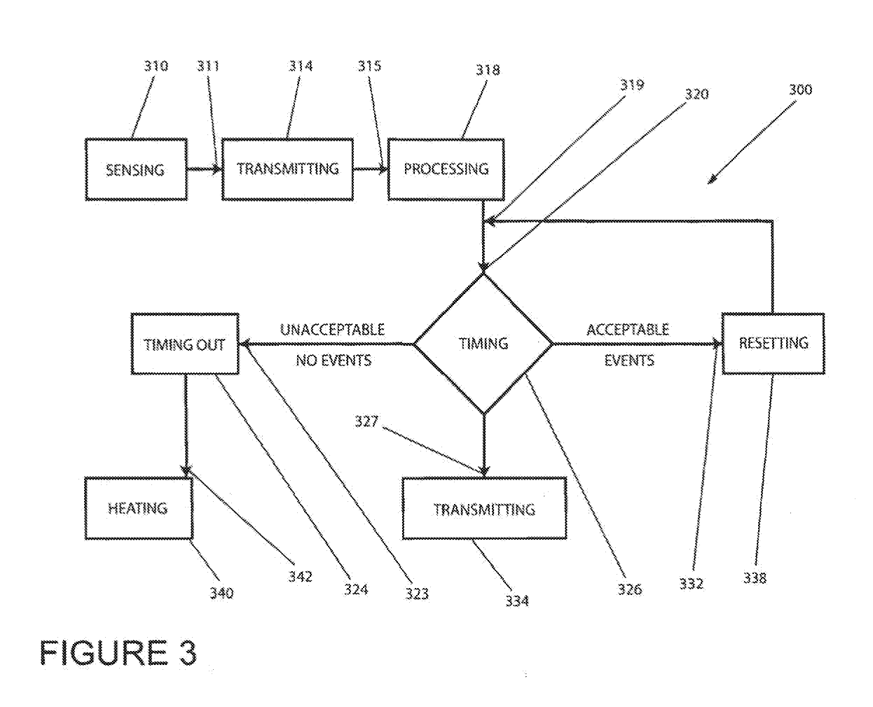

Referring to FIGS. 2 and 3, a method 300 for processing and analysis of the data from the first sensor 23 by the data processor 19 and its timer 122 is illustrated. Data of sensing 310 from the first sensor 23, is conveyed via the sensing data path 311 thus communicating data and transmitting 314 to the data processor 19 through the processor data path 315. Data processing 318 is formatted to separate events of air and oil sensing by the sensor 23 for utilization by the timer 122 and this data is conveyed through the processor data path 320 to timing 326 where a predetermined period is timed between events or lack of events. The preset time period for timing 326 is programmable to virtually any preferred time period from seconds to hours. During the timing 326 the timer 122 may identify that an event consisting of both air and oil flow signals from the first sensor 23 has occurred, and that the occurrence of this event proves full operation of the system 10 is acceptable and in tolerance and that the oil level 49 is verified. In this case the timer 122 will convey this information through the events path 332 to activate the resetting 338 function. The resetting 338 function will convey this information via the reset loop 319 in turn to reset the timing 326 thus to start a new preset time period for analysis of events or lack of events. As an alternative during a similarly programmed preset timing 326 the timer 122 may identify that no event has occurred because only oil or only air flow signals have occurred during the preset timed period, and that the lack of occurrence of an event proves unacceptable operation of the system 10 and that the oil level 49 is not verified; in which case it will convey this information through the no events data path 323, thus timing out 324 the timer 122. When this function occurs we may activate’ heating 340 via the heating data path 342 for a period suitable to warm fluids in the first conduit 26 and the second conduit 36 thus to attempt to restore full function of the flow of the system 10. When full flow of the system 10 is restored the timing 326 will again determine the occurrence of an event where both air and oil signals have been received and reset the timer 122 and the heating 340 will cease because there is no signal from timing out 324. All information generated from timing events 326 may be sent via the transmitting data path 327, which can actuate external indicators such as LED outputs (not shown) or can transmit via wireless using standard communication protocol of various kinds (not shown).

While the invention has been particularly shown and described with respect to the illustrated embodiments thereof, it will be understood by those skilled in the art that the foregoing and other changes in form and details may be made therein without departing from the spirit and scope of the invention.

1. A method for controlling a two pump reserve tank system comprising:
Providing a two pump reserve tank system including
An apparatus reservoir with an apparatus reservoir inlet port, an apparatus reservoir outlet port, and a suction tube disposed within the apparatus reservoir and connected to the apparatus reservoir outlet port;
A reserve reservoir with a reserve reservoir inlet port and a reserve reservoir outlet port;
A first pump with a first pump inlet connected to the apparatus reservoir outlet port through an apparatus conduit and a first pump outlet connected to the reserve reservoir inlet port through a first conduit;
A second pump with a second pump inlet connected to the reserve reservoir outlet port through a second conduit and a second pump outlet connected to the apparatus reservoir inlet port through a third conduit;
A controller connected to the first pump and the second pump; and A first sensor connected to the first conduit wherein the first sensor is connected to a data processor via a data path;
The method comprising
Providing an oil within the two pump reserve tank system wherein the oil is stored within the apparatus reservoir at a near constant oil level and wherein the oil is also stored within the reserve reservoir at a variable oil level;
Using the first sensor to sense the presence of either air or oil in the first conduit in order to create data;
Transmitting the data over the data path from the first sensor to the data processor;
Processing the data in the data processor to verify the near constant oil level in the apparatus reservoir; and
Transmitting a verification signal from the data processor to an indicator.

2. The method of claim 1 further comprises a timer utilizing a timer programmed to determine whether the data is acceptable or unacceptable wherein the data is acceptable if the first sensor senses air and oil as separate events occurring within a predetermined program time and wherein the data is unacceptable if the first sensor senses only air or senses only oil in the predetermined program time.

3. The method of claim 2 further comprising resetting the timer when the timer determines the data is acceptable.

4. The method of claim 3 wherein the reserve tank system further comprises one or more heaters connected to one or more components selected from the group of the apparatus conduit, first conduit, second conduit, third conduit, fourth conduit, or the reserve reservoir.

5. The method of claim 4 further comprising activating the one or more heaters when the data is unacceptable.

6. The method of claim 4 further comprising deactivating the one or more heaters when the data is acceptable.

7. The method of claim 4, wherein the reserve tank system further comprises a temperature sensor connected to the one or more heaters and sensing the temperature of the oil in the two pump reserve tank system.

8. The method of claim 1, wherein the two pump reserve tank system further comprises an anti-siphon valve connected between the apparatus and the apparatus reservoir inlet port through a fourth conduit.

9. The method of claim 8, wherein the reserve tank system further comprises one or more heaters connected to one or more components selected from the group of the apparatus conduit, first conduit, second conduit, third conduit, fourth conduit, or the reserve reservoir.

10. A method for controlling an oil level in a two pump reserve tank system comprising:
Providing a two pump reserve tank system including
An apparatus reservoir with an apparatus reservoir inlet port, an apparatus reservoir outlet port, and a suction tube disposed within the apparatus reservoir and connected to the apparatus reservoir outlet port;
A reserve reservoir with a reserve reservoir inlet port and a reserve reservoir outlet port;
A first pump with a first pump inlet connected to the apparatus reservoir outlet port through an apparatus conduit and a first pump outlet connected to the reserve reservoir inlet port through a first conduit;
A second pump with a second pump inlet connected to the reserve reservoir outlet port through a second conduit and a second pump outlet connected to the apparatus reservoir inlet port through a third conduit;
A heater in thermal communication with the oil;
A controller connected to the first pump, the second pump and the heater; and
A first sensor connected to the first conduit wherein the first sensor is connected to a data processor via a data path, wherein the data processor has a timer; the method comprising:
Sensing the oil level in the apparatus reservoir to determine an oil level data;
Transmitting the oil level data from the first sensor to the processor via the data path;
Processing the oil level data;
Timing the intervals between sensing air and sensing oil to determine an event condition; and
Transmitting the event condition.

11. The method of claim 10, further comprising:
Determining the timing interval exceeds a preset time period corresponding to a time-out condition; and
Activating the heater in response to the time-out condition.

12. The method of claim 10, further comprising:
Resetting the timer in response to an event condition corresponding to an acceptable data condition.

13. The method of claim 10, further comprising:
The two pump reserve tank system further comprising a temperature sensor generating temperature data and connected to the controller; and
The method further comprising transmitting the temperature data to the controller and determining the temperature of the oil.

14. The method of claim 10, further comprising:
The two pump reserve tank system further comprising a second sensor connected to the third conduit and also connected to the data processor wherein the second sensor senses the presence of oil or air in the third conduit; and
The method further comprising determining the availability of oil in the reserve reservoir through data processed from the second sensor.

15. A method for controlling a two pump reserve tank system comprising:
Providing a two pump reserve tank system including
An apparatus reservoir with an apparatus reservoir inlet port, an apparatus reservoir outlet port, a suction tube disposed within the apparatus reservoir and connected to the apparatus reservoir outlet port;
A reserve reservoir with a reserve reservoir inlet port and a reserve reservoir outlet port;
A first pump with a first pump inlet connected to the apparatus reservoir outlet port through an apparatus conduit and a first pump outlet connected to the reserve reservoir inlet port through a first conduit;
A second pump with a second pump inlet connected to the reserve reservoir outlet port through a second conduit and a second pump outlet connected to the apparatus reservoir inlet port through a third conduit;
A controller connected to the first pump and the second pump; and
A first sensor connected to the first conduit wherein the first sensor is connected to a remote data processor via a data path;
The method comprising
Providing an oil within the two pump reserve tank system wherein the oil is stored within the apparatus reservoir at a near constant oil level and wherein the oil is also stored within the reserve reservoir at a variable oil level;
Using the first sensor to sense the presence of either air or oil in the first conduit in order to create data;
Transmitting the data from the first sensor to the remote data processor via the data path;
Processing the data in the remote data processor to verify the near constant oil level in the apparatus reservoir; and
Transmitting a verification signal from the remote data processor to an indicator.

16. The method of claim 15 wherein the data processer further comprises a timer programmed to determine whether the data is acceptable or unacceptable wherein the data is acceptable if the first sensor senses air and oil as separate events occurring within a predetermined program time and wherein the data is unacceptable if the first sensor senses only air or senses only oil in the predetermined program time.

17. The method of claim 16 further comprising resetting the timer when the timer determines the data is acceptable.

18. The method of claim 16 wherein the reserve tank system further comprises one or more heaters connected to one of more components selected from the group of the apparatus conduit, first conduit, second conduit, third conduit, fourth conduit, or the reserve reservoir.

19. The method of claim 18 further comprising activating the one or more heaters when the timer determines the data is unacceptable.

20. The method of claim 18 further comprising deactivating the one or more heaters when the timer determines the data is acceptable.
